(19) United States
(12) Patent Application Publication
(10) Pub. No.: US 2013/0155296 A1
(43) Pub. Date: Jun. 20, 2013

(54) IMAGING APPARATUS AND DISTORTION COMPENSATION METHOD

(71) Applicant: Samsung Electronics Co., Ltd., Gyeonggi-do (KR)

(72) Inventor: Mineki TAOKA, Kanagawa (JP)

(73) Assignee: Samsung Electronics Co., Ltd., Gyeonggi-do (KR)

(21) Appl. No.: 13/715,252

(22) Filed: Dec. 14, 2012

(30) Foreign Application Priority Data
Dec. 14, 2011 (JP) 2011-273568

(51) Int. Cl. H04N 5/357

(52) U.S. Cl. CPC H04N 5/357
USPC 348/241

(57) ABSTRACT

An imaging apparatus for maintaining the frequency of access to a memory for storing an object image for distortion compensation and processing speed of the distortion compensation, while reducing the size of the memory, is provided.

### PRIORITY

This application claims priority under 35 U.S.C. §119(a) to a Japanese Patent Application filed in the Japanese Patent Office on Dec. 14, 2011, and assigned Serial No. 273568/2011, the contents of which are incorporated herein by reference.

### BACKGROUND OF THE INVENTION

1. Field of the Invention

The present invention relates generally to an imaging apparatus and distortion compensation method.

2. Description of the Related Art

There has been a recent proliferation of imaging devices such as digital cameras and digital camcorders, for capturing digital images with imaging elements. Such imaging devices control the imaging element to perform photoelectric conversion of an incident light beam via a lens, generate a digital image from the converted electric signal, and store the digital image in a recording media or an embedded memory.

Since the incident light beam via the lens reaches the imaging element in the imaging apparatus, the generated digital image may contain distortion caused by the lens. As a result, such imaging devices need to be equipped with mechanisms for reducing the digital image distortion.

For example, there is prior art that describes a technology of compensating for distortion using pixel values of a digital image for each block, after reading out the pixel values stored in a frame memory (e.g., Synchronous Dynamic Random Access Memory (SDRAM)) block by block.

However, in the prior art, an inordinate amount of memory space is used for storing pixel values read out from the frame memory to store the plurality of blocks, and since the pixel values in blocks are sequentially loaded, the frequency of access to the frame memory is increased, thus increasing power consumption. The sequential loading of pixel values in blocks also decreases the processing speed of distortion compensation.

### SUMMARY OF THE INVENTION

Accordingly, an aspect of the present invention is to solve at least the above-described problems occurring in the prior art, and to provide at least the advantages described below.

Another aspect of the present invention provides an imaging apparatus and distortion compensation method for preserving capacity of a memory for distortion compensation to which to load pixel values of an object image, while maintaining frequency of access to a memory for storing the object image and processing speed of the distortion compensation

In accordance with an aspect of the present invention, provided is an imaging apparatus including an assignment controller for sequentially assigning pixel values in a range of a number of lines of an image to a memory, and a generator for generating a distortion-compensated image line by line by using the pixel values in the range of the number of lines sequentially assigned to the memory.

In accordance with another aspect of the present invention, provided is a distortion compensation method including sequentially assigning pixel values of a range of a number of lines of an image to a memory, and generating a distortion-compensated image line by line by using the pixel values of the range of the number of lines sequentially assigned to the memory.

### BRIEF DESCRIPTION OF THE DRAWINGS

The above and other features and advantages of the present invention will become more apparent by describing in detail embodiments thereof with reference to the attached drawings in which:

FIG. 1 illustrates image distortion and a size of a memory for distortion compensation;

FIG. 2 illustrates an imaging apparatus, according to an embodiment of the present invention;

FIG. 3 illustrates assigning pixel values to the memory for distortion compensation for an upper half portion of an object image, according to a first embodiment of the present invention;

FIG. 4 illustrates assigning pixel values to the memory for distortion compensation for a lower half portion of the object image, according to a first embodiment of the present invention;

FIG. 5 illustrates pixel values of horizontal sections to be assigned to the memory for distortion compensation;

FIG. 6 illustrates an overwrite operation in the memory for distortion compensation, according to an embodiment of the present invention;

FIG. 7 illustrates assigning pixel values to the memory for distortion compensation, according to a second embodiment of the present invention;

FIG. 8 illustrates assigning pixel values to the memory for distortion compensation, according to a third embodiment of the present invention;

FIG. 9 illustrates a distortion compensator, according to an embodiment of the present invention; and

FIG. 10 illustrates a distortion compensation process, according to an embodiment of the present invention.

### DETAILED DESCRIPTION OF EMBODIMENTS OF THE PRESENT INVENTION

Embodiments of the present invention will be described below with reference to accompanying drawings. Throughout the specification and the drawings, like reference numerals refer to the like elements. Herein, a detailed description of known functions and configurations incorporated herein will be omitted for the sake of clarity and conciseness.

Embodiments will be described in the following sequence: 1. Technical Objective, 2. Configuration of Imaging Apparatus, 3. Specific Example of Assignment Control, 4. Configuration of Distortion Compensator, and 5. Process flow.

1. Technical Objective

When performing a distortion compensation process, an imaging apparatus sequentially reads out pixel values in a range of a number of lines of an object image subject to the distortion compensation (hereinafter, an object image) from a memory for storing the object image. The sequentially read out pixel values are assigned to a memory for the distortion compensation process (hereinafter, memory for distortion compensation). Then, a distortion-compensated image is generated line by line by using the pixel values assigned to the memory for distortion compensation. The memory for distortion compensation is, for example, a Static Random Access Memory (SRAM), and the memory for storing the object image is, for example, a Synchronous Dynamic Random Access Memory (SDRAM).

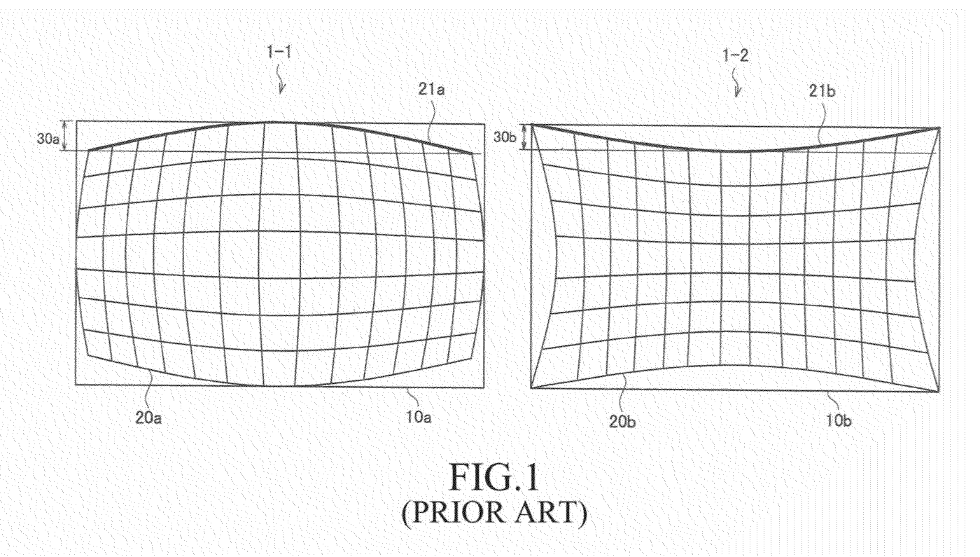

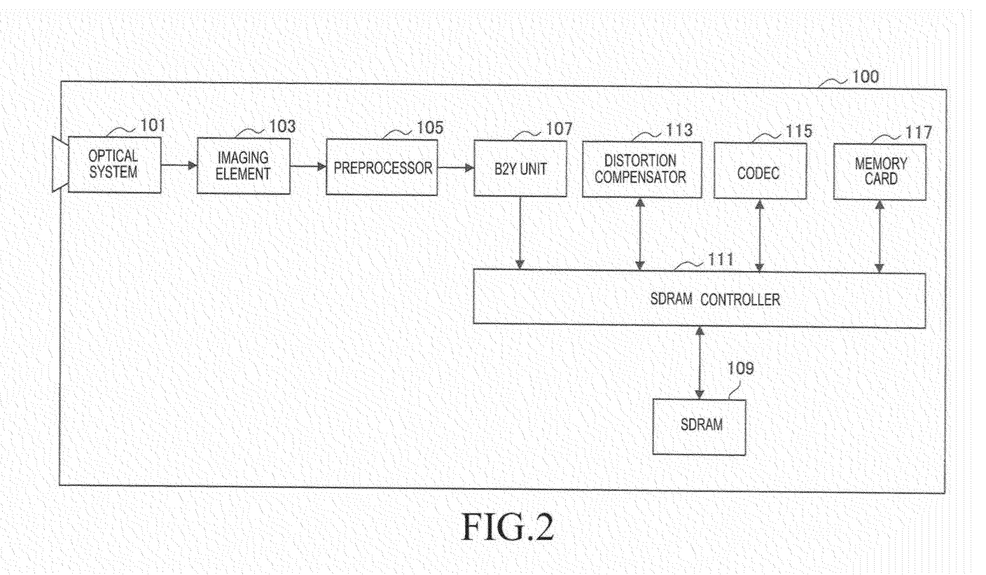

FIG. 1 illustrates image distortion and a size of the memory for distortion compensation. Referring to FIG. 1, an object image 10 involving distortion, and a range 20 within the object image 10 that corresponds to a distortion-less image when projecting the distortion-less image to the object image 10 are illustrated in 1-1 or 1-2. Image distortion shown in 1-1 is called barrel distortion, while image distortion in the FIG. 1-2 is called pincushion distortion. Such image distortion depends on lens characteristics and the focal length. The range 20 corresponding to the distortion-less image may also be called a range corresponding to a distortion-compensated image.

Generally, in the distortion compensation process, each line of the distortion-compensated image is sequentially generated. For example, pixel values of a top line of the distortion-compensated image are generated first, and then, pixel values of a next line from the top are generated. In this manner, pixel values of lines of the distortion-corrected image are sequentially generated line by line in the top to bottom direction of the distortion-compensated image until pixel values of the list line of the distortion-compensated image are generated. This sequential generation of line by line pixel values of the distortion-compensated image leads to a sequential assignment of entire pixel values within a range 30 of a number of lines of the object image 10 to the memory for distortion compensation. Therefore, the memory for distortion compensation has as much a capacitance as it may store all of the pixel values in the range 30 of a number of lines.

As described above, when assigning all of the pixel values in the range 30 of the number of lines to the memory for distortion compensation, the number of lines is required to be equal to or greater than the number of lines of the object image 10 required to generate each line of the distortion-compensated image. In other words, the number of lines is equal to or greater than the maximum number of lines of the object image 10 to be required to generate each line. For example, as shown in 1-1 of FIG. 1, among the lines of the distortion-compensated image, a line of the distortion-compensated image that corresponds to a curve 21a requires the maximum number of lines to be generated. Therefore, as shown in 1-1, the range 30a of the number of lines is a range required to generate a line of the distortion-compensated image that corresponds to the curve 21a.

The range 30a is moved from top to bottom in the object image 10a, and pixel values of the object image 10a are sequentially assigned to the memory for distortion compensation. Likewise, as shown in 1-2, among the lines of the distortion-compensated image, a line of the distortion-compensated image that corresponds to a curve 21b requires the maximum number of lines of the object image. Therefore, as shown in 1-2, the range 30b of the number of lines is a range required to generate a line of the distortion-compensated image that corresponds to the curve 21b. The range 30b is moved from top to bottom in the object image 10b, and pixel values of the object image 10b are sequentially assigned to the memory for distortion compensation.

As such, to perform the distortion compensation process, pixel values of a wide range, such as the range 30a or 30b are assigned to the memory for distortion compensation. In other words, the memory for distortion compensation needs to store pixel values of a wide range, such as the range 30a or 30b. For example, when the object image 10 is a high definition image corresponding to e.g., High Definition TeleVision (HDTV) and Ultra Definition (UD), the size of the memory for distortion compensation may correspond to millions of gates. Thus, it is necessary to reduce the size of the memory for distortion compensation.

As an example of a technology of the distortion compensation, Japanese Patent Publication No. 2004-362069 discloses a technology by which an object image stored in a memory, such as an SDRAM is read out block by block, and distortion of the object image is compensated by using pixel values for each block. According to the technology, the size of the memory for distortion compensation corresponds to a size of a plurality of blocks of the object image. However, in the technology, since pixel values in blocks are sequentially loaded, there is a high frequency of access to the memory for storing the object image, which leads to significant power consumption. The sequential loading of pixel values in blocks also reduces the processing speed of the distortion compensation.

Therefore, the present invention enables a same amount of access to the memory for storing the object image for distortion compensation and processing speed of the distortion compensation while reducing the size of the memory for distortion compensation to which to load pixel values of the object image.

2. Configuration of Imaging Apparatus

FIG. 2 illustrates the imaging apparatus 100, according to an embodiment of the present invention. Referring to FIG. 2, the imaging apparatus 100 includes an optical system 101, an imaging element 103, a preprocessor 105, a B2Y unit 107, an SDRAM 109, an SDRAM controller 111, a distortion compensator 113, a codec 115, and a memory card 117. The distortion compensator 113 is an example of an assignment controller and a generator.

The optical system 101 guides a light beam to the imaging element 103 located in the imaging apparatus 100. In other words, the optical system 101 forms an image on an imaging surface of the imaging element 103.

The imaging element 103 performs photoelectric conversion. That is, the imaging element 103 converts the light beam guided from the optical system 101 to an electric signal, and uses an Analog-to-Digital converter (A/D converter- not shown) to perform A/D conversion on the electric signal. As a result, a Bayer pattern of RAW data is obtained. The imaging device 103 is, for example, a Charge Coupled Device (CCD) image sensor, or a Complementary Metal Oxide Semiconductor (CMOS) image sensor.

The preprocessor 105 performs a preprocess task on the RAW data. For example, the preprocessor 105 performs shading correction, defect compensation, or noise elimination, on the RAW data.

The B2Y unit 107 converts the RAW data output from the preprocessor 105 into a YcbCr image represented by luminance (Y) and chrominance (Cb, Cr). The YcbCr image involves distortion caused by the optical system 101, which is the object image 10 subject to distortion compensation. Pixels of the YcbCr image are stored in the SDRAM 109 under control of the SDRAM controller 111.

The SDRAM 109 stores an image to be temporarily preserved in the imaging apparatus 100. For example, the SDRAM 109 stores the object image 10, the YcbCr image, and the distortion-compensated image resulting from the distortion compensation process for the YcbCr image.

The SDRAM controller 111 controls writing to and loading from the SDRAM 109. For example, the SDRAM controller 111 controls writing of pixel values of the YcbCr image output by the B2Y unit 107 and pixel values of the distortion-compensated image output by the distortion compensator 113 to the SDRAM 109. Furthermore, the SDRAM controller 111 controls loading of pixel values of the YcbCr image to the distortion compensator 113 and loading of the pixel values of the distortion-compensated image to the codec 115.

The distortion compensator 113 sequentially assigns pixel values of a division range of a number of lines of the object image 10 to the memory for distortion compensation. The distortion compensator 113 also uses the pixel values of the division range of the number of lines to be sequentially assigned to the memory for distortion compensation, to generate distortion-compensated image line by line. The method of assigning pixel values makes it possible to maintain the same amount of access to the memory for storing the object image for distortion compensation and processing speed of the distortion compensation, while preserving the capacity of the memory for distortion compensation, to which to load pixel values of the image for distortion compensation.

The codec 115 performs compression encoding, such as MPEG (Motion Pictures Experts Group) (e.g., MPEG2, MPEG4, or H.246) on the stored distortion-compensated image. The codec 115 outputs an image resulting from the compression encoding to the memory card 117. When a still image is captured rather than an image or a moving picture, the codec 115 performs the compression encoding, such as JPEG (Joint Photographic Experts Group), or TIFF (Tagged Image File Format), on the distortion-compensated image.

The memory card 117, such as a Flash memory, stores an image resulting from the compression encoding performed by the codec 115

3. Specific Example of Assignment Control

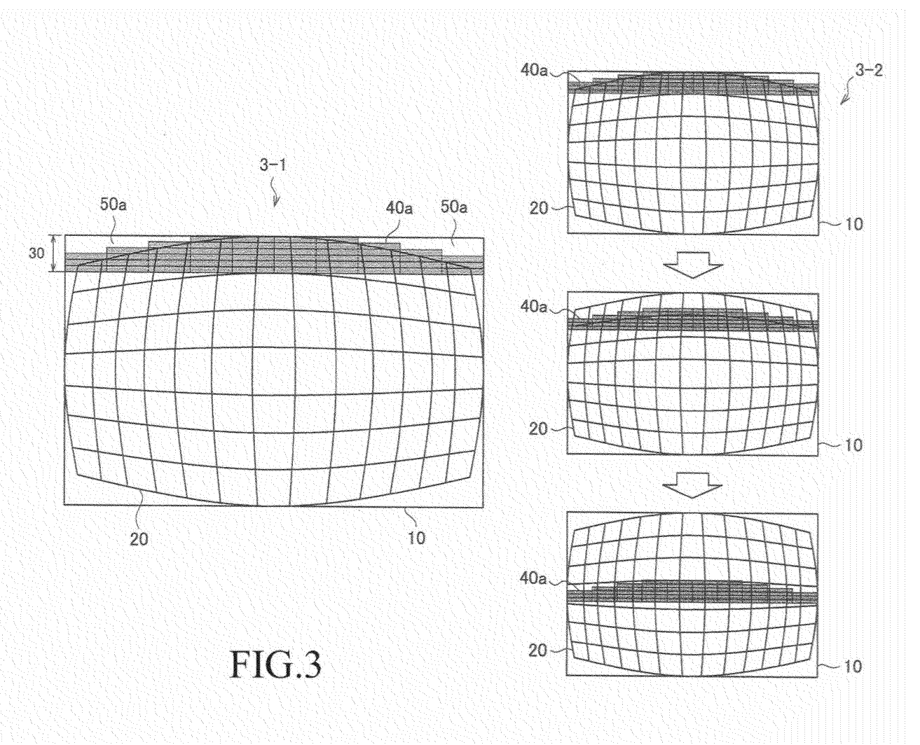

A method of assigning pixel values in an embodiment of the present invention will now be described with reference to FIGS. 3 to 8. The method will be explained based on examples of assigning first to third pixel values.

FIGS. 3 to 6 illustrate an example of assigning first pixel values.

FIG. 3 illustrates assigning pixel values to the memory for distortion compensation in an upper portion of the object image 10, according to a first embodiment of the present invention. Referring to FIG. 3, the object image 10 involving distortion, and a range 20 in the object image 10 corresponding to the distortion-compensated image when projecting the distortion-compensated image onto the object image 10 are shown. The range 30 of a number of lines of the object image 10, a range 40a of pixel values actually assigned to the memory for distortion compensation in the range 30 (hereinafter, an assignment range), and a range 50a not actually assigned to the memory for distortion compensation (hereinafter, an exclusive range) are also shown. The assignment range 40a and the exclusive range 50a are applied to the upper portion of the object image 10.

As shown in 3-2, the range 30 is moved from top to center of the object image 10 in the vertical direction, and pixel values of the assignment range 40a in the range 30 are sequentially assigned to the memory for distortion compensation. Even if the range 30 is moved, pixel values of the exclusive range 50a, as shown in 3-1, are not assigned to the memory for distortion compensation. In other words, the assignment range 40a is moved from top to center of the object image 10 and pixel values contained in the assignment range 40a are assigned to the memory for distortion compensation. The object image 10 is sequentially loaded line by line to the memory for distortion compensation.

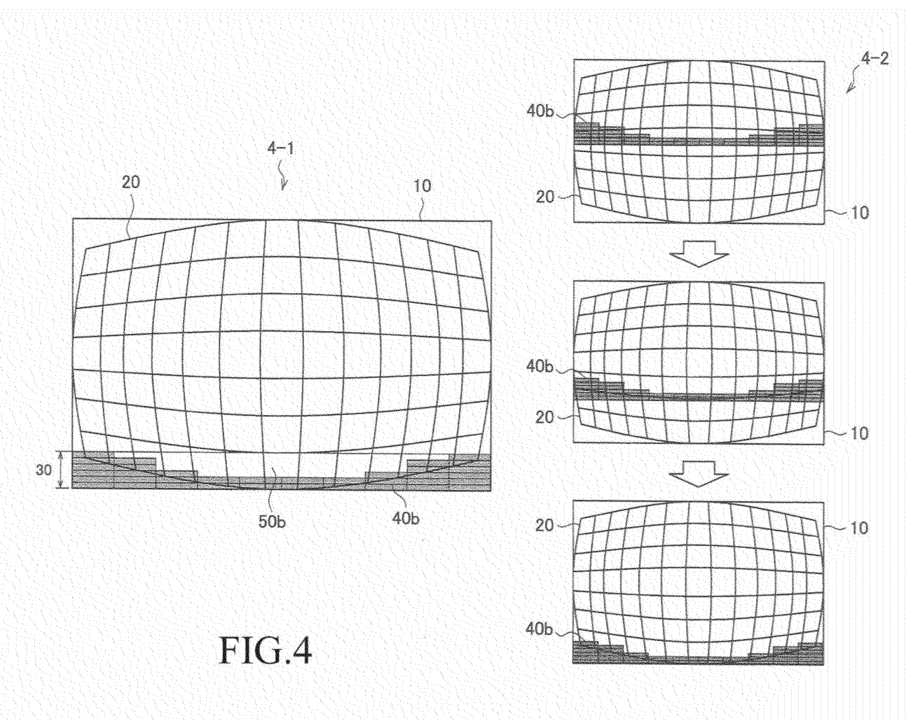

FIG. 4 illustrates assigning pixel values to the memory for distortion compensation for a lower portion of the object image 10, according to a first embodiment of the present invention. Referring to FIG. 4, similarly to 3-1, the object image 10 and the range 20 in the object image corresponding to the distortion-compensated image are shown in 4-1. The range 30 of a number of lines of the object image 10, the assignment range 40b, and the exclusive range 50b are also shown. The assignment range 40b and the exclusive range 50b are applied to the lower portion of the object image 10.

As shown in 4-2, the range 30 is moved from center to bottom of the object image 10 in the vertical direction, and pixel values of the assignment range 40b in the range 30 are sequentially assigned to the memory for distortion compensation. Even if the range 30 is moved, pixel values of the exclusive range 50b, as shown in 4-1, are not assigned to the memory for distortion compensation. In other words, the assignment range 40b is moved from center to bottom of the object image 10 and pixel values contained in the assignment range 40b are assigned to the memory for distortion compensation.

As such, even when pixel values of the object image 10 are assigned to the memory for distortion compensation, it is possible to generate each line of the distortion-compensated image. Specifically, pixel values of the object image 10 to be required to generate each line of the distortion-compensated image, i.e., pixel values of surrounding pixels of a curve (e.g., the curve 21a) corresponding to each line of the distortion-compensated image are all included in the pixel values of the assignment range when the assignment range 40 is moved, as shown in 3-2 and 4-2. Thus, when the distortion compensation process is performed by use of the pixel values in the assignment range 40, it is possible to generate each line of the distortion-compensated image. In other words, any line of the distortion-compensated image may be generated without using pixel values in the exclusive range 50 of the range 30.

As such, pixel values of the object image 10 are sequentially assigned to the memory for distortion compensation.

As an example of a first characteristic, the number of lines in the range 30 (hereinafter, line number N′ or ′N lines) is equal to or greater than the number of lines of the object image required to generate each line of the distortion-compensated image. In other words, the line number N is equal to or greater than the maximum number of lines of the object image 10 to be required to generate each line of the distortion-compensated image. The range 30 of N lines is the same as described with reference to FIG. 1. As such, once the line number N is determined, any line of the distortion-compensated image may be calculated from pixel values stored in the memory for distortion compensation in the distortion compensation process.

As an example of a second characteristic, pixel values of the range 30 of N lines to be sequentially assigned to the memory for distortion compensation are those excluding at least a portion of pixel values that are not needed to generate a line, not yet generated, of the distortion-compensated image from among all pixel values of the range 30 of N lines. Conventionally, as shown in FIG. 1, pixel values to be sequentially assigned to the memory for distortion compensation were those of all pixels included in the range 30. However, in the present invention, as described above with reference to FIGS. 3 and 4, pixel values to be sequentially assigned to the memory for distortion compensation excludE pixel values of the exclusive range 50 from among all pixel values of the range 30. If the range 30 of N lines is moved in the top-to-bottom direction, the exclusive range 50 is also moved in the same manner.

The exclusive range 50 moved in this manner includes pixel values that are not needed to generate a not-yet generated line of the distortion-compensated image. For example, pixel values of the exclusive range 50a, represented by 3-1, are those not used in any later distortion compensation process. Also, as represented by 3-2, any exclusive range 50a moved together with the assignment range 40a (and the range 30 of N lines) includes no pixel values to be used in the later distortion compensation process. In the present invention, at least a portion of pixel values that are not needed to generate a not-yet generated line of the distortion-compensated image are excluded from those to be assigned to the memory for distortion compensation.

In this manner, the assignment method of the embodiment of the present invention reduces pixel values to be assigned to the memory for distortion compensation. Thus, the size of the memory for distortion compensation is decreased. Since pixel values not assigned to the memory for distortion compensation are not necessary to generate a not-yet generated line, even when pixel values of the exclusive range 50 were not assigned to the memory for distortion compensation when each line of the object image 10 was loaded, it is not necessary to re-load the pixel values. Thus, the extent of access to the memory, such as SDRAM for storing the object image 10 is constant compared with that of the conventional technology. Furthermore, since the object image 10 may be loaded line by line and does not need to be re-loaded, processing speed of the distortion compensation is not decreased.

As an example of a third characteristic, the distortion compensator 113 assigns pixel values of sections in the horizontal direction (hereinafter, horizontal sections) determined based on a relative position of a line in the range 30, for each line in the range 30 of N lines. The horizontal sections for at least one line in the range of the number of lines exclude those that are not needed to generate any line of the distortion-compensated image.

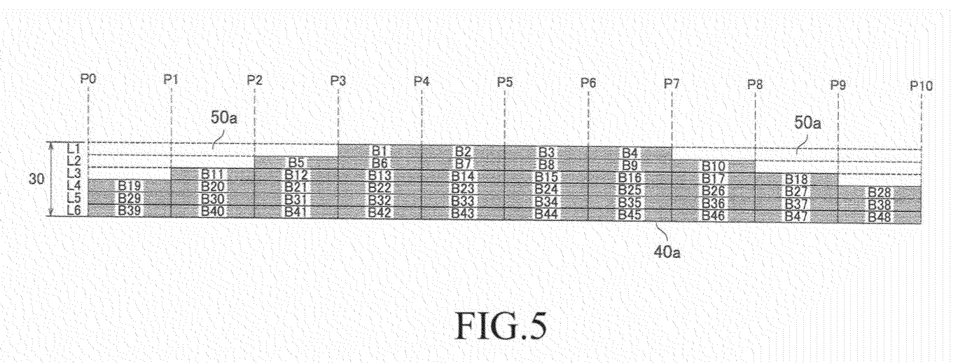

FIG. 5 illustrates pixel values of horizontal sections to be assigned to the memory for distortion compensation. Referring to FIG. 5, the range 30 of N lines, the assignment range 40a, and the exclusive range 50a are shown. These ranges are the same as those shown in FIG. 3. For purposes of explanation, the range 30 of N lines is a range of 6 lines, L1 to L6. Sections of P0 to P10 correspond to the length of one line of the object image 10.

For each line in the range 30 of L1 to L6, pixel values of the horizontal sections determined based on the relative position of each line in the range 30 are assigned to the memory for distortion compensation. For example, for L1 on top of the range 30, pixel values of horizontal sections of P3 to P7 are assigned to the memory for distortion compensation. For L2 and L3 located second and third from the top of the range 30, respectively, pixel values of horizontal sections of P3 to P8 and P2 to P9, respectively, are assigned to the memory for distortion compensation. For L4 to L6 located fourth to sixth from the top of the range 30, pixel values of horizontal sections of P1 to P10, i.e., all pixel values of a line may be assigned.

As shown in FIG. 3, sections of P0 to P3 and P7 to P10 for L1 exclude those that are not needed to generate any line of the distortion-compensated image. In other words, if the range 30 is moved, as in 3-2 of FIG. 3, pixel values for each line of the distortion-compensated image may be calculated without using pixel values contained in sections P0 to P3 and P7 to P10 for L1. Similarly, sections of P0 to P2 and P8 to P10 for L2 exclude those that are not needed to generate any line of the distortion-compensated image. The horizontal sections are symmetrical in the horizontal direction, since image distortion caused by the lens is typically symmetrical.

As such, by determining horizontal sections for each line in the range 30 of N lines and assigning pixel values of the horizontal sections to the memory for distortion compensation, as described in connection with FIGS. 3 and 4, the assignment range 40 and the exclusive range 50 moved along with the movement of the range 30 may be implemented. By using the assignment range 40 and the exclusive range 50, an amount of pixel values to be assigned to the memory for distortion compensation is reduced.

As an example of a fourth characteristic, each of the horizontal sections consists of one or more of a plurality of blocks that constitute a line. Referring to FIG. 5, for example, 10 blocks constitute a line in the range 30, and horizontal sections for L1 consist of 4 blocks. Likewise, horizontal sections for L2, L3, L4, L5, and L6 consist of blocks of B5 to B10, B11 to B18, B19 to B28, B29 to B38, and B39 to B48, respectively. Each block includes a certain number of pixel values. As such, by assigning pixel values in blocks to the memory for distortion compensation, an operation of remaining necessary pixel values while eliminating unnecessary pixel values by overwriting when pixel values for a subsequent new line need to be loaded is easily performed.

As an example of a fifth characteristic, the horizontal sections include upper sections applied when the range 30 consists of lines of the upper portion of the object image 10 and lower sections applied when the range 30 consists of lines of the lower portion of the object image 10. As described above with reference to FIGS. 3 and 4, the assignment range 40a and exclusive range 50a for the upper portion of the object image 10 are different from the assignment range 40b and exclusive range 50b for the lower portion of the object image 10. That is, horizontal sections of each line for the upper portion and those for the lower portion of the object image 10 are different from each other.

In an example in which the object image 10 involves barrel distortion, the range 30 is moved from top to bottom in the object image 10, and pixel values of the range 30 are assigned to the memory for distortion compensation, as shown in FIGS. 3 and 4. In the upper portion of the object image 10, pixels nearer to the center of the object image 10 among pixels of the object image 10 necessary to generate each line of the distortion-compensated image are assigned to the memory for distortion compensation in an earlier stage, compared to pixels nearer to the far right hand or far left hand. Thus, pixels nearer to the center of the object image 10 are assigned to the memory for distortion compensation for longer durations.

However, in the lower portion of the object image 10, pixels nearer to the far right hand or far left hand of the object image 10 among pixels of the object image 10 necessary to generate each line of the distortion-compensated image are assigned to the memory for distortion compensation in an earlier stage, compared to pixels nearer to the center. Thus, pixels nearer to the far right hand or far left hand of the object image 10 are assigned to the memory for distortion compensation for longer durations.

The image distortion caused by the lens may make significantly change pixels to be assigned to the memory for distortion compensation in the upper portion and the lower portion of the object image 10, as described above, by considering much of what is symmetrical in the vertical direction. As horizontal sections, therefore, if there are sections to be applied to both the upper and the lower portion of the object image 10, it is possible to load pixel values of the object image 10 necessary to generate the entire distortion-compensated image.

As an example of a sixth characteristic, if pixel values of a first line in the range 30 are assigned to the memory for distortion compensation after pixel values of a second line are assigned to the memory for distortion compensation, horizontal sections for the first line may include horizontal sections for the second line. For example, as shown in FIGS. 3 and 4, if the range 30 is moved from top to bottom in the object image 10, pixel values of a lower line in the range 30, as shown in FIG. 5, are assigned to the memory for distortion compensation after pixel values of an upper line are assigned to the memory for distortion compensation. In an embodiment, pixel values of L4 are assigned to the memory for distortion compensation after pixel values of L3 are assigned to the memory for distortion compensation.

In this case, horizontal sections P0 to P10 for L4 include horizontal sections P1 to P9 for L3. Based on this relationship, pixels values of each line of the object image 10 are most numerous when assigned to the memory for distortion compensation for the first time, and after that, decrease in number. Thus, pixel values of each line of the object image 10 are loaded only once, which contributes to reduction of the size of the memory for distortion compensation while reducing the frequency of access to the memory for storing the object image for distortion compensation and maintaining processing speed of the distortion compensation.

As an example of a seventh characteristic, if pixel values of a new line of the object image 10 are to be assigned to the memory for distortion compensation, blocks in the range 30 at an identical position in the horizontal direction are taken to be in a group, and for each group, pixel values of blocks of a new line overwrite pixel values of blocks of the line firstly assigned among groups to the memory for distortion compensation.

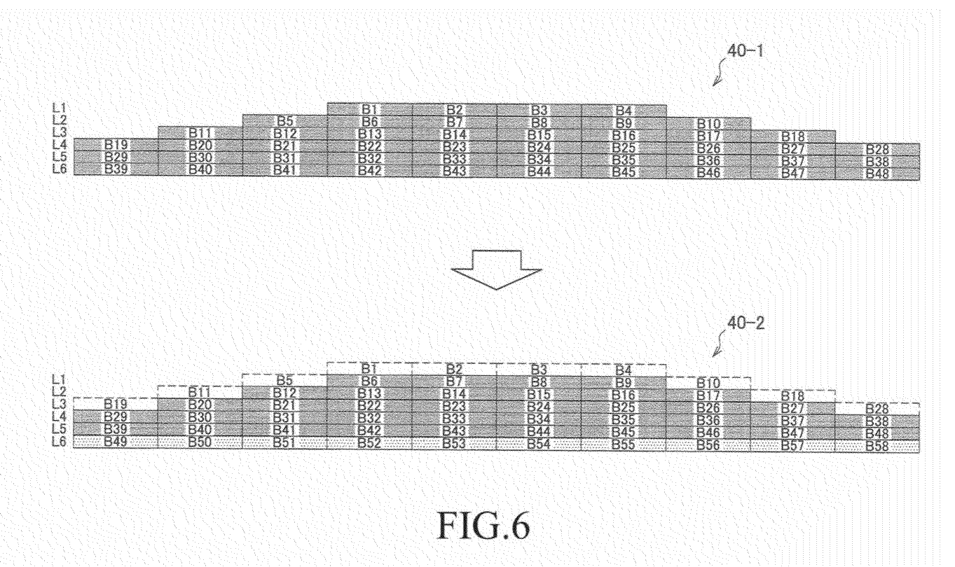

FIG. 6 illustrates an overwrite operation in the memory for distortion compensation, according to an embodiment of the present invention. Referring to FIG. 6, as shown in an assignment range 40-1 of the first range 30, pixel values of blocks B1 to B48 are assigned to the memory for distortion compensation. Blocks at an identical position in the horizontal direction are considered to be in a group. For example, B19, B29, and B39 are grouped to be one, and B1, B6, B13, B22, B32, and B42 are grouped to be another. In this manner, there are 10 groups in the assignment range 40-1.

If the range 30 is moved and pixel values of a new line are loaded to the memory for distortion compensation, pixel values of blocks of a line first assigned to the memory for distortion compensation are overwritten by pixel values of the blocks of the new line, in the memory for distortion compensation. For example, pixel values of a block B49 of the new line overwrite those of a block B19 of L4 firstly assigned among groups. Pixel values of a block B52 of a new line overwrite those of a block B1 of L1 first assigned among groups. In this manner, for each of 10 groups, pixel values of a block of a new line overwrite those of a line first assigned among the groups to the memory for distortion compensation.

Since it is clear in advance where to assign pixel values of a new line in the memory for distortion compensation, pixel value assignment is implementable by simple processing and circuit configuration.

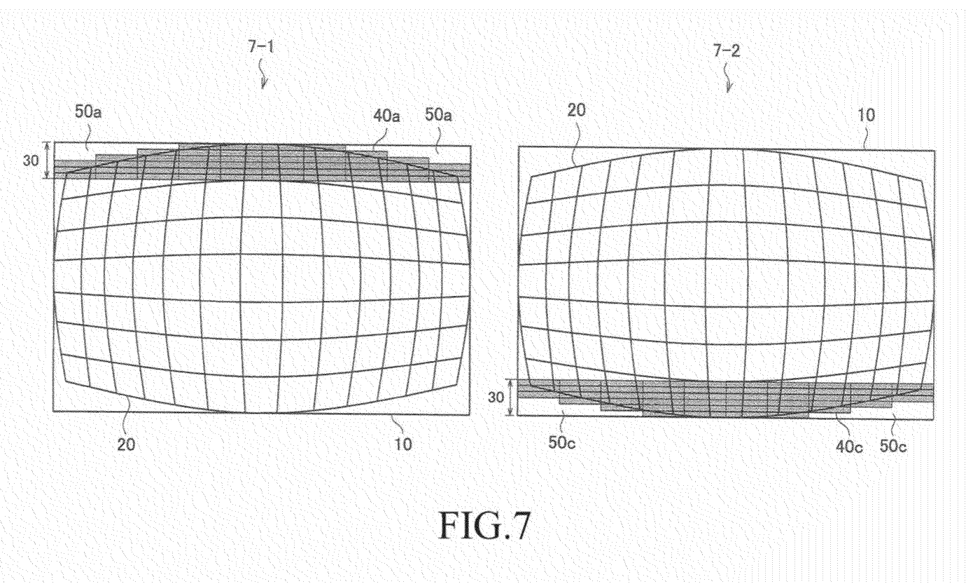

FIG. 7 illustrates assigning pixel values to the memory for distortion compensation, according to a second embodiment of the present invention. Referring to FIG. 7, the object image 10 involving distortion, and the range 20 within the object image 10 corresponding to the distortion-compensated image when projecting the distortion-compensated image onto the object image 10 are shown. Also, in 7-1, the assignment range 40a and the exclusive range 50a for the upper portion of the object image 10 are shown, and in 7-2, an assignment range 40c and an exclusive range 50c for the lower portion of the object image 10 are shown. The assignment ranges 40a and 40c are symmetrical in the horizontal direction.

In FIG. 7, the range 30 is moved from top to center of the object image 10 for the upper portion of the object image 10, and pixel values of the assignment range 40a of the range 30 are sequentially assigned to the memory for distortion compensation. The range 30 is moved from bottom to center of the object image 10 for the lower portion of the object image 10, and pixel values of the assignment range 40c of the range 30 are sequentially assigned to the memory for distortion compensation. That is, in FIG. 7, for the lower portion of the object image 10, pixel values are read out upward in the bottom to top direction of the object image 10.

As such, pixel values of the object image 10 are sequentially assigned to the memory for distortion compensation. The first to seventh characteristics of the assignment method described with reference to the example of assigning the first pixel values are also applied to this assignment example. New characteristics of the assignment method in the embodiment of the present invention are now described in detail with reference to the example of assigning the second pixel values.

For example, the distortion compensator 113 sequentially assigns pixel values of a new line of the object image 10 in one vertical direction for the upper portion of the object image 10, and sequentially assigns pixel values of a new line of the object image 10 in the other vertical direction for the lower portion of the object image 10. As described above with reference to FIG. 7, for example, the distortion compensator 110 sequentially assigns pixel values of the assignment range 40a from top to center in the vertical direction for the upper portion of the object image 10, and sequentially assigns pixel values of the assignment range 40b from bottom to center in the vertical direction for the lower portion of the object image 10.

In this manner, by sequentially loading assigning pixel values in different directions for the upper portion and the lower portion, the process of assigning pixel values of the upper portion of the object image 10 to the memory for distortion compensation and the process of assigning pixel values of the lower half portion of the object image 10 to the memory for distortion compensation are performed in the same manner. This facilitates simplification of the processing and circuit configuration.

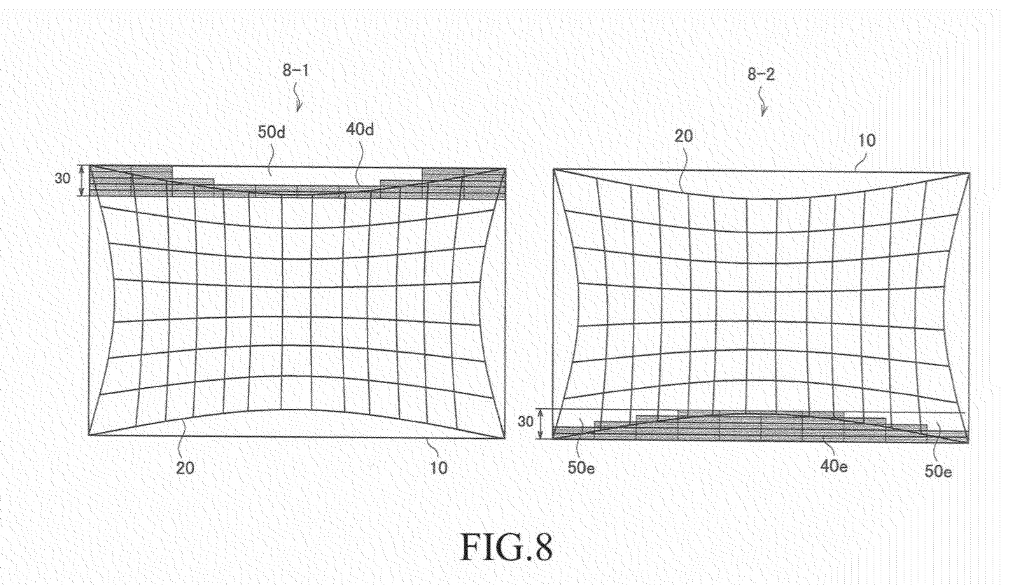

FIG. 8 illustrates assigning pixel values to the memory for distortion compensation, according to a third embodiment of the present invention. Referring to FIG. 8, the object image 10 involving distortion, and the range 20 within the object image 10 corresponding to the distortion-compensated image when projecting the distortion-compensated image onto the object image 10 are shown. Distortion of the object image 10 corresponds to pincushion distortion. Also, in 8-1, an assignment range 40d and an exclusive range 50d for the upper half portion of the object image 10 are shown, and in 8-2, an assignment range 40e and an exclusive range 50e for the lower half portion of the object image 10 are shown.

In FIG. 8, the range 30 is moved from top to center of the object image 10 for the upper half portion of the object image 10, and pixel values of the assignment range 40d of the range 30 are sequentially assigned to the memory for distortion compensation. The range 30 is moved from center to bottom of the object image 10 for the lower half portion of the object image 10, and pixel values of the assignment range 40e of the range 30 are sequentially assigned to the memory for distortion compensation. In other words, in FIG. 8, pixel values are read out downward in the top to bottom direction of the object image 10.

The distortion of the object image is the barrel distortion in the example of assigning the first pixel values while the distortion of the object image is pincushion distortion in the example of assigning the third pixel values. Even if the distortion type is different, the first to seventh characteristics described above are also applied to this example.

4. Configuration of Distortion Compensator

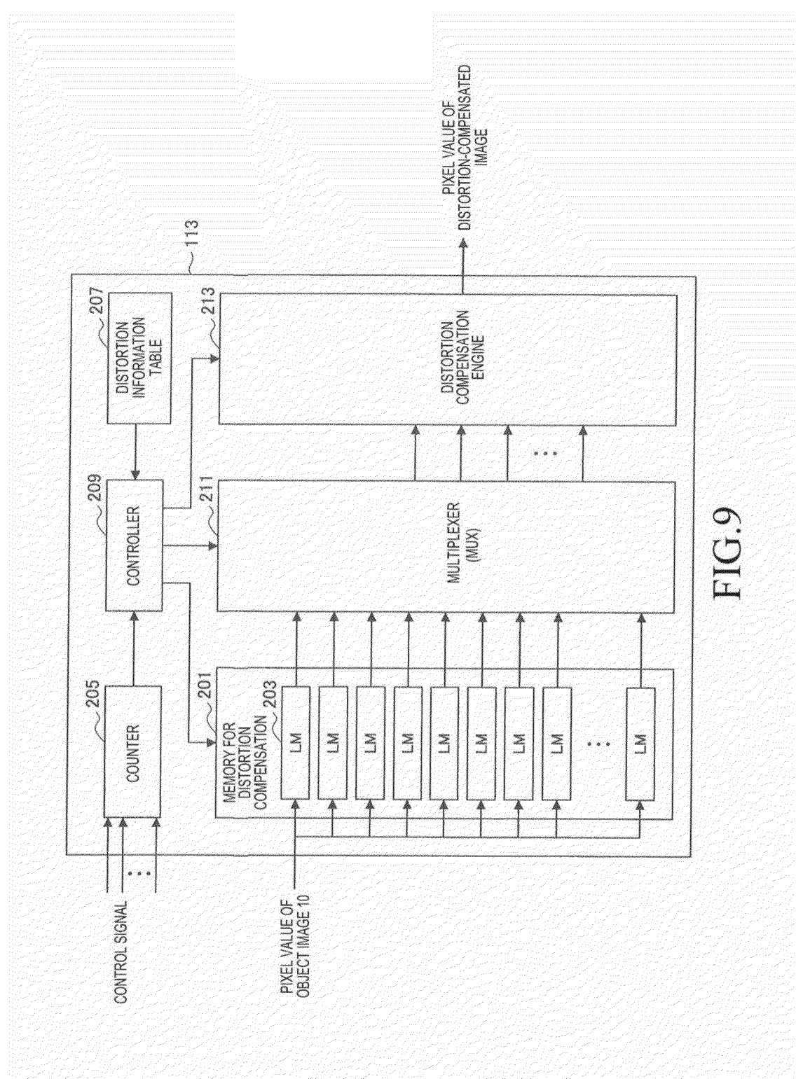

FIG. 9 illustrates the distortion compensator 113, according to an embodiment of the present invention. Referring to FIG. 9, the distortion compensator 113 includes a memory for distortion compensation 201, a counter 205, a distortion information table 207, a controller 209, a MUltipleXer (MUX) 211, and a distortion compensation engine 213. The controller 209 is an example of the assignment controller, and the distortion compensation generator is an example of the generator.

The memory for distortion compensation 201 stores pixel values of the range 30 of the object image 10. For example, the memory for distortion compensation 201 includes a plurality of Line Memories (hereinafter, LM) 203. Each LM 203 stores pixel values of a block shown in FIG. 5, and pixel values of each line of the object image 10 are sequentially loaded from the SDRAM 109 by a Direct Memory Access (DMA). The memory for distortion compensation assigns pixel values of lines of a newly loaded object image 10 under control of the controller 209.

The counter 205 monitors load conditions of the object image 10. For example, the counter 205 monitors which pixels of which line of the object image 10 are loaded, which is referred to as the load conditions, upon reception of a control signal by the DMA. The control signals are, for example, line sync signals and enable sync signals. The counter 205 outputs the load conditions to the controller 209.

The counter 205 also monitors whether a line of the center of the object image 10 in the vertical direction was loaded. The counter 205 notifies the controller 209 of the purpose by turning a flag ON when the line of the center in the vertical line was loaded. Then, the controller 209 may assign pixel values for each of the upper and lower portions of the object image 10.

The distortion information table 207 stores information about positions (i.e., projected positions) in the object image 10 that correspond to pixels of the distortion-compensated image (hereinafter, corresponding information). The distortion-compensated image is a distortion-less image, and the object image 10 involves distortion. As described above with reference to FIG. 1, the manner in which the object image 10 is distorted through the optical system 101, i.e., which position in the object image 10 each pixel of the distortion-compensated image corresponds to, depends on characteristics of the optical system and focal length. Thus, it is possible to store the information based on the type of the optical system or focal length in the distortion compensation table 207 in advance. By saving the information, the distortion compensation process is enabled.

The controller 209 assigns pixel values of the range 30 of the object image 10 excluding pixel values of the exclusive range 50 (resulting in pixel values of the assignment range 40) to the memory 201 for distortion compensation. For example, pixel values of each line of the object image 10 are sequentially loaded from the SDRAM 109 by Direct Memory Access (DMA), and the controller 209 assigns pixel values of the assignment range 40 of the range 30 to the memory for distortion compensation 201, and does not assigns pixel values of the exclusive range 50 to the memory for distortion compensation 201. The controller 209 also controls the memory for distortion compensation 201 and embodies characteristics of the assignment methods in the embodiments of the present invention.

The controller 209 also controls the distortion compensation process by using pixel values of the object image 10 assigned to the memory 201 for distortion compensation. For example, the controller 209 controls the MUX to provide a pixel value necessary to generate each pixel of the distortion-compensated image from the LM 203 to the distortion compensation engine 213. Furthermore, the controller 209 indicates to the distortion compensation engine 213, which pixel values are to be used from among those provided from the LM 203 to generate pixel values of the distortion-compensated image.

The MUX 211 selects one or more LMs 203 from among all the LMs 203 included in the memory for distortion compensation, and provides pixel values stored in the selected LM 203 to the distortion compensation engine 213.

The distortion compensation engine 213 generates the distortion-compensated image line by line by using pixel values in the range 30 of the object image 201 excluding pixel values of the exclusive range 50 (resulting in pixel values of the assignment range 40), sequentially assigned to the memory 201 for distortion compensation. For example, the distortion compensation engine 213 uses pixel values indicated by the controller 209 among those stored in the LM 203 obtained by the MUX 211, to generate pixel values of the distortion-compensated image. The distortion compensation engine 213 generates the pixel values of the distortion-compensated image line by line.

5. Process Flow

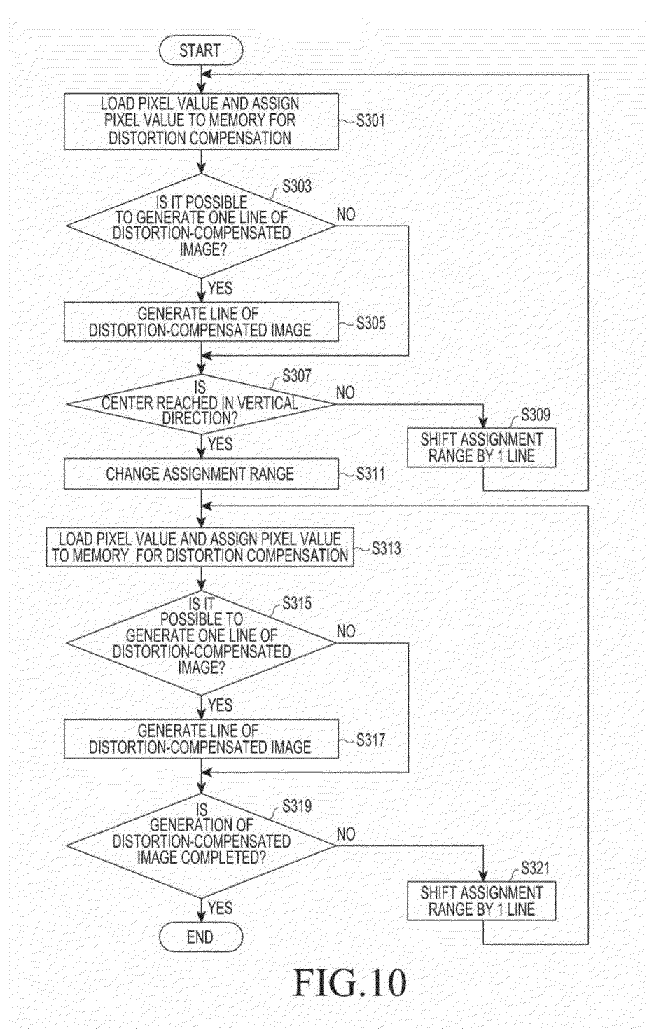

FIG. 10 illustrates the distortion compensation process, according to an embodiment of the present invention.

In step S301, once pixel values of a new line of the object image 10 are loaded, the controller 209 assigns pixel values of the range 30 of the object image 10 excluding pixel values of the exclusive range 50 (resulting in pixel values of the assignment range 40) to the memory 201 for distortion compensation. In step S303, the controller 209 determines whether it is possible to generate the distortion-compensated image line by line by using the pixel values (i.e., pixel values of the assignment range 40) assigned to the memory for distortion compensation. If it is possible to generate the distortion-compensated image line by line, the process proceeds to step S305. Otherwise, the process proceeds to step S307.

In step S305, the distortion compensation engine 213 generates the distortion-compensated image line by line by using pixel values of the range 30 of the object image 201 excluding pixel values of the exclusive range 50 (resulting in pixel values of the assignment range 40), assigned to the memory 201 for distortion compensation.

In step S307, the controller 209 determines whether the range 30 reaches the center of the object image 10 in the vertical direction. If the range 30 reaches the center, the process proceeds to step S311. Otherwise, the process proceeds to step S309.

In step S309, the controller 209 shifts the assignment range 40 by one line, and the process returns to step S301.

In step S311, the controller 209 changes the assignment range 40 of the range 30, as shown in FIGS. 3, 4, 7, and 8.

Steps S313, S315 and S317 involve the same processes as those in steps S301, S303, and S305. In step S319, the controller 209 determines whether the generation of the distortion-compensated image has been completed. If the distortion-compensated image has been completed, the process ends. Otherwise, the process proceeds to step S321.

In step S321, the controller 209 shifts the assignment range 40 by one line, and the process returns to step S313.

According to embodiments of the present invention, the frequency of access to the memory for distortion compensation 201 that stores the object image 10 for distortion compensation and processing speed is not changed, and the size of the memory for distortion compensation 201, to which to load pixel values of the object image 10 may also be reduced.

Although embodiments of the present invention have been described with reference to accompanying drawings, it may be appreciated that the present invention is not limited thereto. It would be obvious to one or ordinary skill in the art that various variations or modifications to the embodiments are also attainable within the scope of the claims of the present invention.

For example, although barrel distortion and pincushion distortion were taken as examples of the distortion of the object image 10, any types of distortion could be the distortion of the object image 10.

Furthermore, although 6 or 5 were taken as an example of the line number N, it could be any number if it is equal to or greater than what is necessary for distortion compensation of the object image 10.

The imaging apparatus may be any image-capturing device available, such as a digital camcorder and a digital camera.

In addition, although each frame image of a moving picture is taken as an example of the object image for distortion compensation, a still image may also be the object image.

Furthermore, any other formats of image (e.g., a Red, Green, Blue (RGB) image) than the foregoing YcbCr image may be the object image.

In addition, the steps of the distortion compensation process may occur in a different order than described in the flowchart of FIG. 10, or processed in parallel.

According to the present invention, the imaging apparatus and distortion compensation method enables a maintained frequency of access to a memory for storing an object image and processing speed of the distortion compensation, while preserving the capacity of a memory for distortion compensation to which to load pixel values of the object image.

The above-described embodiments of the invention may be embodied as hardware, software or a combination of hardware and software. Software may be stored in a volatile or non-volatile storage device such as Read Only Memory (ROM) and the like irrespective of erasing or rewriting, a memory such as a Random Access Memory (RAM), a memory chip, a device, and a integrated circuit, or a storage medium that is capable of performing optical or magnetic recording and machine-reading such as Compact Disc (CD), Digital Versatile Disc (DVD), optical disc, and magnetic tape. A memory may be an example of machine-readable storage media that are suitable for storing a program including instructions to implement the embodiments, or programs. Therefore, the invention may include a program including a code to implement an apparatus or a method claimed in a claim of the specification, and a machine-readable storage medium including the program, for example, a computer-readable storage medium. The program may be transferred electronically through a medium such as a communication signal transferred through a wired or wireless connection, and the invention may appropriately include an equivalent medium.

While the invention has been shown and described with reference to certain embodiments thereof, it will be understood by those skilled in the art that various changes in form and details may be made therein without departing from the spirit and scope of the invention as defined by the appended claims.

What is claimed is:

1. An imaging apparatus comprising:
an assignment controller which sequentially assigns pixel values of a range of a number of lines of an image to a memory; and
a generator which generates a distortion-compensated image line by line by using the pixel values of the range of the number of lines sequentially assigned to the memory,
wherein the number of lines is equal to or greater than a number of lines of the image required to generate each line of the distortion-compensated image, and
wherein the pixel values of the range of the number of lines exclude at least a portion of pixel values that are not needed to generate a not-yet generated line of the distortion-compensated image from among all pixel values in the range of the number of lines.

2. The imaging apparatus of claim 1, wherein the assignment controller assigns the memory pixel values of horizontal sections determined based on a relative position of a line in the range of the number of lines, for each line in the range,
wherein horizontal sections for at least one line in the range of the number of lines exclude sections that are not needed to generate any line of the distortion-compensated image.

3. The imaging apparatus of claim 2, wherein the horizontal sections may include upper sections applied when the range of the number of lines consists of lines in an upper half portion of the image, and lower sections applied when the range of the number of lines consists of lines in a lower half portion of the image.

4. The imaging apparatus of claim 2, wherein each of the horizontal sections includes one or more of a plurality of blocks that constitute a line.

5. The imaging apparatus of claim 2, wherein if pixel values of a first line in the range of the number of lines are assigned to the memory after pixel values of a second line are assigned to the memory, the horizontal sections for the first line may include horizontal sections for the second line.

6. The imaging apparatus of claim 5, wherein each of the horizontal sections includes one or more of a plurality of blocks that constitute a line, and
wherein the assignment controller includes an operation of grouping blocks at an identical position in a horizontal direction within the range of the number of lines when assigning pixel values of a new line of the image, and for each group, overwriting pixel values of blocks of a line first assigned to the memory from among groups with pixel values of blocks of the new line.

7. The imaging apparatus of claim 1, wherein the assignment controller includes an operation of sequentially assigning pixel values of a new line of the image to the memory in one vertical direction for an upper portion of the image, and sequentially assigning pixel values of a new line of the image to the memory in another vertical direction for a lower portion of the image.

8. A distortion compensation method comprising:
sequentially assigning pixel values of a range of a number of lines of an image to a memory; and
generating a distortion-compensated image line by line by using the pixel values of the range of the number of lines sequentially assigned to the memory,
wherein the number of lines is equal to or greater than a number of lines of the image required to generate each line of the distortion-compensated image, and
wherein the pixel values of the range of the number of lines exclude at least a part of pixel values that are not needed to generate a not-yet generated line of the distortion-compensated image from among all pixel values in the range of the number of lines.
